(19) United States
(12) Patent Application Publication
(10) Pub. No.: US 2004/0028982 A1
(43) Pub. Date: Feb. 12, 2004

(54) Fuel cell separator manufacturing method and fuel cell separator

(76) Inventor: Ayumi Horiuchi, Okazaki-shi (JP)

Correspondence Address: BIRCH STEWART KOLASCH & BIRCH, PO BOX 747, FALLS CHURCH, VA, 22040-0747, US

(21) Appl. No.: 10/638,372

(22) Filed: Aug. 12, 2003

(30) Foreign Application Priority Data
Aug. 12, 2002 (JP) 2002-234737

(51) Int. Cl. H01M 8/02; B29C 43/02

(52) U.S. Cl. 429/34; 264/241; 264/319

(57) ABSTRACT

A fuel cell separator is manufactured by charging a porous molding material into a mold, compression molding the porous material to create a porous molded body, then impregnating predetermined regions of the porous molded body with a binder to form dense areas. The process lends itself well to the low-cost, high-volume production of fuel cell separators having a dense structure, which separators, even when bearing a complex channel geometry, can readily be imparted with a uniform density and uniform pores and moreover exhibit a high planar and dimensional precision.

### BACKGROUND OF THE INVENTION

1. Field of the Invention

The present invention relates to a method of manufacturing fuel cell separators. The invention also relates to fuel cell separators obtained by this method.

2. Prior Art

Fuel cells are devices which, when supplied with a fuel such as hydrogen and with atmospheric oxygen, cause the fuel and oxygen to react electrochemically, producing water and directly generating electricity. Because fuel cells are capable of achieving a high fuel-to-energy conversion efficiency and are environmentally friendly, they are being developed for a variety of applications, including small-scale local power generation, household power generation, simple power supplies for isolated facilities such as campgrounds, mobile power supplies such as for automobiles and small boats, and power supplies for satellites and space development.

Such fuel cells, and particularly solid polymer fuel cells, are built in the form of modules composed of a stack of at least several tens of unit cells. Each unit cell has a pair of plate-like separators with raised and recessed areas on either side thereof that define a plurality of channels for the flow of gases such as hydrogen and oxygen. Disposed between the pair of separators in the unit cell are a solid polymer electrolyte membrane and gas diffusing electrodes made of carbon paper.

The role of the fuel cell separators is to confer each unit cell with electrical conductivity, to provide flow channels for the supply of fuel and air (oxygen) to the unit cells, and to serve as a separating boundary membrane. Characteristics required of the separators include high electrical conductivity, high gas impermeability, electrochemical stability and hydrophilic properties.

Such fuel cell separators are produced in a number of different ways. One prior-art process involves the use of a machining operation to cut channels in a plate of porous fired carbon. In another process, described in U.S. Pat. No. 6,187,466, a slurry prepared from graphite powder, binder resin and cellulose fibers is formed into a sheet by a papermaking process, following which the sheet is graphitized.

Because strength is often a problem in these porous separators, separators of increased strength obtained by filling the pores to form dense areas are also in use.

Known techniques for filling pores include, for example, the method described in JP-A 11-195422, in which an amount of binder smaller than the theoretically required amount is used to impregnate the voids of a high pressure-molded separator and form areas of high density.

However, in prior-art separator manufacturing methods, graphitization leads to increased costs. When a machining operation is required to cut channels, production takes more time, resulting in higher costs, in addition to which the production yield declines. Moreover, cutting is poorly suited to the production of fuel cell separators having a complex channel geometry.

In the aforementioned prior-art method for densifying separators, high-pressure molding is carried out using a material having poor flow properties. As a result, strain arises in the mold and the molding machine, compromising the planar and dimensional precision of the resulting fuel cell separator.

### SUMMARY OF THE INVENTION

It is therefore one object of the invention to provide a method which is capable of the low-cost, high-volume production of fuel cell separators having a dense structure, which separators, even when bearing a complex channel geometry, can readily be imparted with a uniform density and uniform pores and moreover exhibit a high planar and dimensional precision. Another object of the invention is to provide fuel cell separators obtained by this method.

We have discovered that fuel cell separators which have a dense structure, which, even when bearing a complex channel geometry, can readily be provided with a uniform density and uniform pores, and which exhibit a high planar and dimensional precision can be fabricated by charging a porous molding material into a mold, compression molding the porous material within a given pressure range to create a porous molded body, and impregnating predetermined regions of the porous molded body with a binder to form dense areas.

Accordingly, the invention provides a method of manufacturing fuel cell separators which includes the steps of charging a porous molding material into a compression mold, compression molding the porous material at a pressure of 0.98 to 19.6 MPa, and preferably 4.9 to 14.7 MPa, to create a porous molded body, then impregnating predetermined regions of the porous molded body with a binder to form dense areas.

The porous molded body typically has a porosity of 1 to 50%.

Impregnation of the porous molded body with the binder is preferably carried out at a temperature of 0 to 200° C. and a pressure of −0.1 to 2.0 MPa.

The invention additionally provides a fuel cell separator obtained by the foregoing fuel cell manufacturing method.

### BRIEF DESCRIPTION OF THE DIAGRAMS

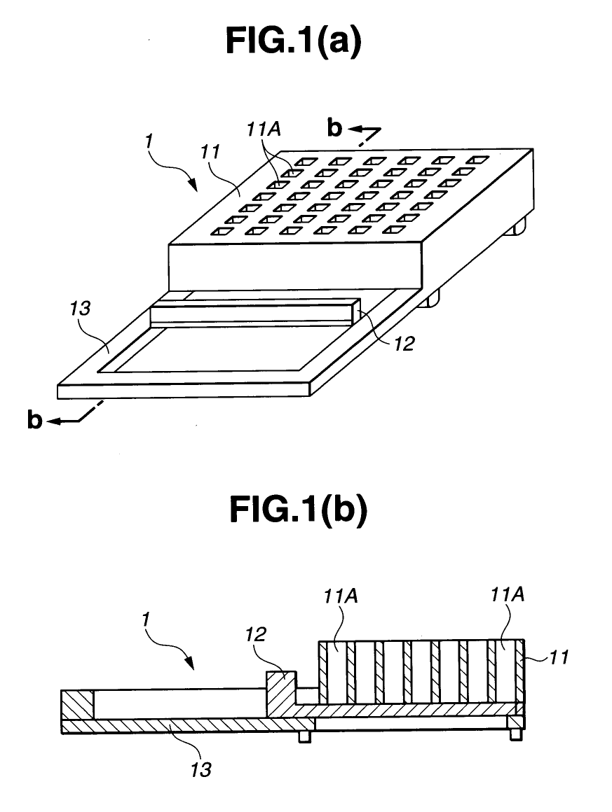

FIG. 1 illustrates a porous material charging device such as may be used according to one embodiment of the invention. FIG. 1a is a perspective view of the device, and FIG. 1b is a sectional view taken along line b-b in FIG. 1a.

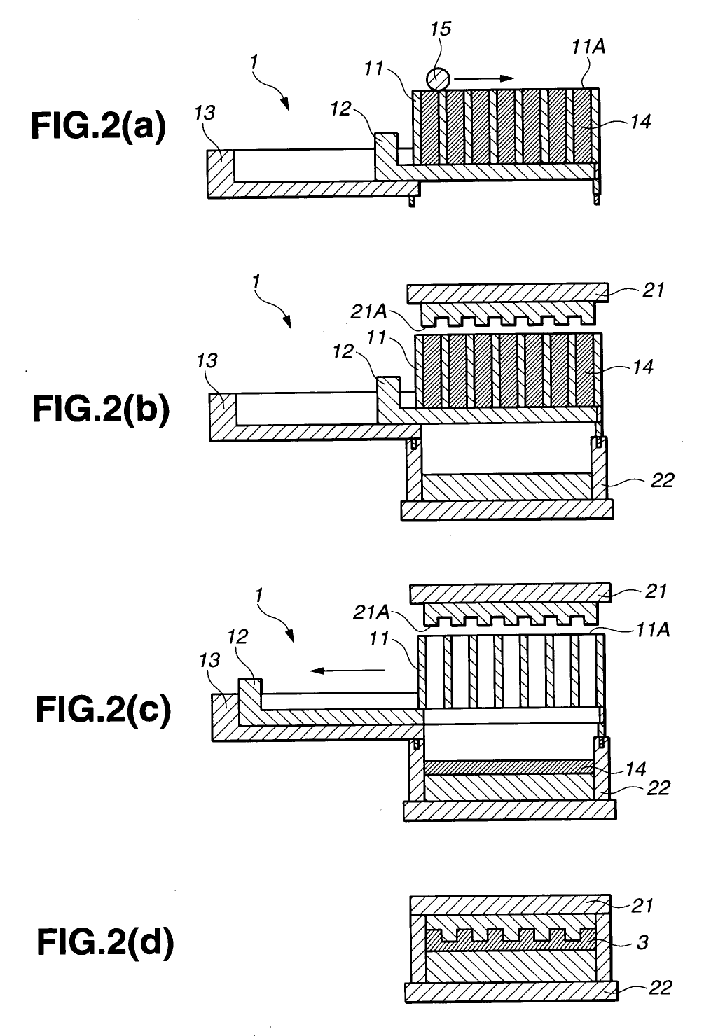

FIG. 2 shows schematic sectional views of individual steps, from charging of the porous material to compression molding, according to the same embodiment of the invention.

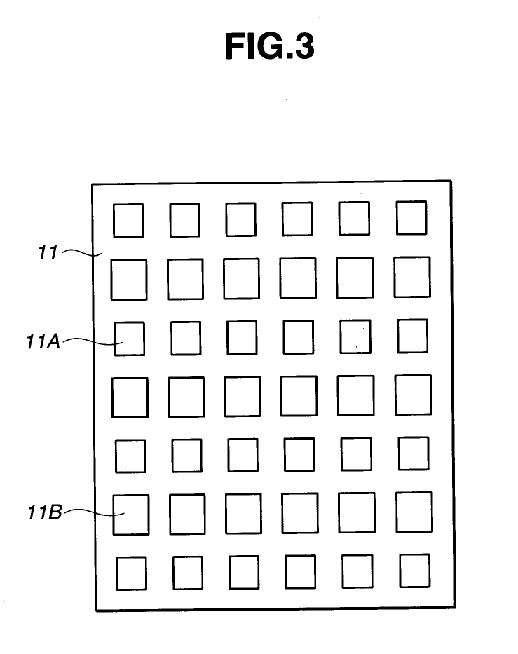

FIG. 3 is a top view showing the charging member of a charging device such as may be used in another embodiment of the invention.

### DETAILED DESCRIPTION OF THE INVENTION

The objects, features and advantages of the invention will become more apparent from the following detailed description, taken in conjunction with the foregoing diagrams.

As noted above, the method of manufacturing fuel cell separators according to the present invention involves charging a porous molding material into a compression mold, compression molding the porous material at a pressure of 0.98 to 19.6 MPa to create a porous molded body, then impregnating predetermined regions of the porous molded body with a binder to form dense areas.

The porous molding material used in the method of the invention may be any suitable molding material commonly employed in the production of porous fuel cell separators, including molding compounds prepared by subjecting a mixture of electrically conductive powder and resin to a compounding process.

The electrically conductive powder is not subject to any particular limitation. Illustrative examples include natural graphite, synthetic graphite and expanded graphite. The conductive powder has an average particle size in a range of preferably about 10 to 100 μm, and most preferably 20 to 60 μm.

The resin may be suitably selected from among thermoset resins, thermoplastic resins and other resins commonly used in fuel cell separators. Specific examples of resins that may be used include phenolic resins, epoxy resins, acrylic resins, melamine resins, polyamide resins, polyamideimide resins, polyetherimide resins and phenoxy resins. If necessary, these resins may be heat treated.

No limitation is imposed on the proportions in which the conductive powder and the resin are blended, although it is desirable for the porous molding material to include, per 100 parts thereof: 50 to 99 parts by weight, and especially 65 to 90 parts by weight, of the conductive powder; and 1 to 50 parts by weight, and especially 5 to 20 parts by weight, of the resin.

In the practice of the invention, these blended components are generally used after being subjected to compounding by any suitable method. Blended components that have been stirred, granulated and dried by known methods may be used, although it is preferable to use as the porous molding material a blend which has been screened to prevent secondary agglomeration and adjusted to a specific particle size. The porous molding material has an average particle size which varies with the particle size of the conductive powder used, but is preferably at least 60 μm. The particle size distribution is preferably from 10 μm to 2.0 mm, more preferably from 30 μm to 1.5 mm, and most preferably from 50 μm to 1.0 mm.

If necessary, the porous molding material may include also an inorganic filler such as carbon fibers, other carbonaceous materials or activated alumina in an amount of 0.1 to 20 parts by weight, and preferably 1 to 10 parts by weight, per 100 parts by weight of the overall porous molding material.

The pressure applied during compression molding is generally from 0.98 to 19.6 MPa, and preferably from 4.9 to 14.7 MPa. At a molding pressure of less than 0.98 MPa, a strength sufficient to maintain the shape of the porous molded body may not be achieved. On the other hand, at a pressure greater than 19.6 MPa, strain arises in the molding machine and mold, which may lower the planar and dimensional precision of the fuel cell separator ultimately obtained. Moreover, pores may become filled, so that control of the pores in the porous molded body becomes difficult.

By carrying out compression molding within the above pressure range, a porous molded body of good precision can be achieved and the pores in the molded body can easily be controlled. Furthermore, when the subsequently described binder is then impregnated into the porous molded body, selective impregnation to required areas of the molded body can easily be achieved.

The binder may be any suitable material which can impregnate the porous molded body to form a dense structure. Illustrative examples of preferred binders include resole-type phenolic resins, liquid epoxy resins, liquid silicone rubbers, liquid acrylic rubbers, liquid dispersions of fluorocarbon resin, silicone resins and fluororubbers.

Any suitable technique may be used to impregnate the above binder into the porous molded body, such as dip coating and spray coating. For example, it may be advantageous to use a method in which a liquid dispersion prepared by dispersing any of the above binder stock solutions or binders in a suitable solvent—examples of which include water, alcohols such as methanol and ethanol, ketones such as acetone and methyl ethyl ketone, nonpolar solvents such as cyclohexane and aromatic compounds such as toluene—to a solids content of less than 100 wt % is applied to the porous molded body by dip coating at a temperature below the curing temperature of the binder, following which the solvent is removed at 30 to 80° C. over a period of 0.5 to 4 hours and the binder is subsequently cured by 1 to 24 hours of heating at or above the curing temperature of the binder.

Impregnation of the binder into the porous molded body may be carried out under any suitable conditions. That is, impregnation may be carried out under either a reduced pressure or an applied pressure, and at a temperature at which the binder does not cure. However, it is desirable to carry out impregnation at a temperature of 0 to 200° C., preferably 15 to 150° C., and most preferably 20 to 80° C.; and at a pressure of −0.1 to 2.0 MPa, and preferably −0.9 to 1.0 MPa.

At a temperature of less than 0° C., the binder viscosity becomes high, which may discourage impregnation of the binder into the porous molded body. On the other hand, at a temperature above 200° C., evaporation of the solvent may make the viscosity of the solution difficult to adjust as desired.

At pressures lower than −0.1 MPa, a vacuum is required. On the other hand, at a pressure greater than 2.0 MPa, selective impregnation of the binder may become difficult to achieve.

In the method of the invention, the “predetermined regions” which are impregnated with the above binder may be any suitable places on the porous molded body without particular limitation. The term “predetermined regions” preferably refers to at least regions of the separator that are required to be dense, but may refer to the entire porous molded body. Here, the “regions of the separator that are required to be dense” are often areas that require strength, such as places that are bolt-tightened during stack assembly.

In the practice of the invention, after the porous molded body has been impregnated with the binder, the impregnated body may additionally be subjected to hydrophilizing treatment and/or water-repelling treatment.

The porous molded body has a porosity of preferably 1 to 50%, and most preferably 10 to 30%. At a porosity of less than 1%, impregnation of the binder may be difficult. On the other hand, at a porosity of more than 50%, precise formation of the desired geometry in the molded body may be impossible.

In working the invention, any suitable method may be used to charge the porous molding material into the compression mold. For example, use may be made of a charging device like that shown in FIG. 1.

Referring to FIG. 1, the illustrated charging device 1 has a charging member 11, a slide plate 12 situated below the charging member 11, and a base 13 which is integrally molded with the charging member 11 and forms an outside border that encloses the slide plate 12.

The charging member 11 has charging holes 11A of substantially rectangular shape, which holes 11A are arranged as a matrix of evenly spaced rows and columns. The charging holes 11A pass vertically through the charging member, are open at the bottom, and have a bore which can be selected as appropriate for the separator being fabricated.

It has already been noted above that the base 13 is formed integrally with the charging member 11. In addition, as shown in FIG. 1b, the portion of the base 13 over which the charging holes 11A are situated is hollow.

The base 13 and the charging member 11 have formed therebetween a gap of a given size, within which the slide plate 12 is disposed so as to be freely slideable.

The slide plate 12 is designed to be freely movable from a condition in which the bottoms of the charging holes 11A are closed to a condition in which they are open.

Charging of the porous molding material into a compression mold using a charging device 1 of the foregoing construction and compression molding may be carried out as follows.

As shown in FIG. 2a, a porous molding material 14 is charged into the charging holes 11A in the charging member 11, then is leveled off with a leveling rod 15, thereby filling the holes 11A with predetermined amounts of the porous molding material 14.

Next, as shown in FIG. 2b, the charging device 1 filled with the porous material 14 is set on the bottom half 22 of a compression mold in a press having a top mold half 21 and bottom mold half 22. The top half 21 bears a pattern 21A for forming gas flow channels in the fuel cell separator.

It is also possible in this case to place a preform on the bottom half 22 of the mold.

After the charging device 1 has been set on the bottom half 22 of the mold, as shown in FIG. 2c, the slide plate 12 is moved to the left side in the diagram so as to open the bottoms of the charging holes 11A, allowing the porous molding material 14 filled into the holes to fall onto the bottom half 22 of the mold.

As shown in FIG. 2d, by clamping the mold shut in this state with the top half 21 thereof and compression molding at a mold temperature of, say, 100 to 250° C., and preferably 140 to 200° C., and a molding pressure of 0.98 to 19.6 MPa, there is obtained a porous molded body 3.

The porous molded body is then impregnated in predetermined regions where density is required such as for increased strength by dip coating or some other suitable technique with a liquid dispersion consisting of a binder dispersed in a suitable dispersing medium such as water to a solids content of less than 100 wt %. The solvent is subsequently removed from the binder-impregnated molded body at a temperature of 0 to 80° C. over a period of 0.5 to 4 hours, following which the binder is cured at 30 to 250° C. for 1 to 24 hours, thereby yielding a fuel cell separator having both porous areas and dense areas.

In the above-described embodiment, the bottom mold half 22 has no pattern for forming gas flow channels. However, the bottom half 22 may also be provided with a gas flow channel-forming pattern, in which case a fuel cell separator having gas flow channels on both surfaces can be obtained.

The porous molding material can be charged in varying amounts for areas of differing volume on the separator, such as gas flow channels. In such cases, use can be made of a technique in which the above-described charging device 1 is employed to charge the porous molding material a plurality of times only in required places. Alternatively, a technique may be employed that varies the amount of porous molding material charged using a charging member 11 having first charging holes 11A and second charging holes 11B of different bores, as shown in FIG. 3.

As described above, because the method of the invention involves charging a porous molding material into a compression mold, compression molding the porous material at a given pressure to create a porous molded body, and impregnating predetermined regions of the porous molded body with a binder to form dense areas, it is capable of the low-cost, high-volume production of fuel cell separators having a dense structure, which separators, even when bearing a complex channel geometry, can easily be imparted with a uniform density and uniform pores, and moreover exhibit a high planar and dimensional precision.

Also, because molding can be carried out using a single molding material, it is possible to avoid problems such as distortion and breakage of the separator that tend to arise with the use of composite materials due to differences between the constituent materials in such properties as the coefficient of expansion and the shrinkage factor.

Furthermore, because low-pressure molding is possible, separators of high precision can be obtained and the pores can easily be controlled. This makes it easy to impregnate binder only in required places so as to selectively form dense areas. Dense areas formed this way are capable of enhancing the strength of the separator as a whole, and thus enable a sufficient strength and durability to impact to be achieved even in separators having porous areas.

Fuel cell separators obtained by the inventive manufacturing method having the above-described features are highly suitable for use as separators in solid polymer fuel cells.

### EXAMPLES

The following examples and comparative examples are provided to illustrate the invention and are not intended to limit the scope thereof. Average particle sizes given below were measured using a Microtrak particle size analyzer.

### Example 1

A porous molding material was prepared by mixing 90 parts by weight of artificial graphite powder having an average particle size of 90 μm and 10 parts by weight of phenolic resin to form a composition, granulating and drying the composition, then screening the dried material so as to adjust the particle size to 0.5 or less.

The porous molding material 14 was charged into the charging holes 11A of the charging device 1 shown in FIGS. 1 and 2, and leveled off with a leveling rod 15 to fill each hole. Next, the slide plate 12 was slid so as to open the bottom of the charging holes 11A, thereby charging the porous molding material 14 onto the bottom half 22 of a compression mold.

In this example, there were a total of 36 charging holes 11A, each having a cross-sectional size of 15×15 mm.

The top half 21 of the mold was then clamped shut over the bottom half 22 and compression molding was carried out at a mold temperature of 170° C. and a molding pressure of 13 MPa to form a porous molded body 3.

A liquid dispersion prepared by dispersing a resole-type phenolic resin in water to a solids content of 64 wt % was applied by dip coating at room temperature to predetermined regions of the resulting porous molded body 3 at the left and right edges thereof in FIG. 2. Next, the solvent was removed at 80° C. over a period of 1 hour, following which the resin was cured at 140° C. for 4 hours to form dense areas, thereby giving a fuel cell separator having porous areas and dense areas.

### Example 2

A porous molding material was prepared by mixing 88 parts by weight of artificial graphite powder having an average particle size of 60 μm and 12 parts by weight of phenolic resin to form a composition, granulating and drying the composition, then screening the dried material so as to adjust the particle size to 0.5 or less.

Aside from using this porous molding material and changing the molding pressure to 11 MPa, a porous molded body 3 was obtained in the same way as in Example 1. The porous molded body 3 was subjected to binder impregnation treatment as in Example 1, giving a fuel cell separator.

### Example 3

A porous molding material was prepared by mixing 86 parts by weight of artificial graphite powder having an average particle size of 20 μm and 14 parts by weight of phenolic resin to form a composition, granulating and drying the composition, then screening the dried material so as to adjust the particle size to from 0.5 to 1.0 mm.

Aside from using this porous molding material and changing the molding pressure to 5 MPa, a porous molded body 3 was obtained in the same way as in Example 1. The porous molded body 3 was subjected to binder impregnation treatment as in Example 1, giving a fuel cell separator.

### Comparative Example 1

Aside from changing the molding pressure to 50 MPa, a porous molded body was obtained in the same way as in Example 1 using the same porous molded material. The porous molded body was then subjected to binder impregnation treatment as in Example 1, giving a fuel cell separator.

The fuel cell separators obtained in each of the above examples and comparative examples were measured and evaluated to determine the state of the molded body, density, thickness variation, flexural strength, flexural modulus and specific resistance in both porous areas and dense areas, as well as the porosity and gas permeability in the porous areas and the degree of impregnation in the dense areas. The following methods were used. The results are given in Tables 1 and 2.

1. State of Molded Body

The molded body was visually examined to determine whether it was of a porous or dense structure.

2. Density

The density was calculated from the measured weight and volume for the respective areas of the fuel cell separator.

3. Thickness Variation

The deviation in thickness for a 2 mm thick molded body was measured using a micrometer (Mitutoyo Corporation).

4. Porosity

Measured by mercury injection porosimetry.

5. Degree of Impregnation

The degree of impregnation with respect to the porosity of the porous areas was computed as follows:

[(weight of dense area after impregnation−weight of porous area before impregnation)/(theoretical weight of binder when impregnated into all pores)]×100

6. Gas Permeability

Measured in general accordance with the “Equal Pressure Method” described in JIS K-7126.

7. Flexural Strength, Flexural Modulus

Measured in general accordance with the method described in ASTM D790.

8. Specific Resistance

Measured by the four-probe method described in JIS H-0602.

TABLE 1

| | Porous areas | | | | | | | |
|---|---|---|---|---|---|---|---|---|
| | | | | | Gas | | | |
| | State of | | Thickness | | permeability | Flexural | Flexural | Specific |
| | molded | Density | variation | Porosity | (cc · cm/ | strength | modulus | resistance |
| | body | (g/cm³) | (μm) | (%) | (cm² · s · cmHg) | (MPa) | (GPa) | (mQ · cm) |
| Example 1 | porous | 1.3 | 40 | 21 | 1 × 10⁻³ | 21 | 12 | 5 |
| Example 2 | porous | 1.3 | 40 | 22 | 1 × 10⁻³ | 25 | 13 | 4 |
| Example 3 | porous | 1.3 | 30 | 20 | 1 × 10⁻³ | 23 | 5.9 | 12 |
| Comparative | porous | 1.6 | 150 | 5 | 1 × 10⁻⁵ | 25 | 18 | 4 |
| Example 1 | | | | | | | | |

TABLE 2

| | Dense areas | | | | | | |
|---|---|---|---|---|---|---|---|
| | State of | | Thickness | Degree of | Flexural | Flexural | Specific |
| | molded | Density | variation | impregnation | strength | modulus | resistance |
| | body | (g/cm³) | (μm) | (%) | (MPa) | (GPa) | (mΩ · cm) |
| Example 1 | dense | 1.7 | 40 | 100 | 21 | 12 | 5 |
| Example 2 | dense | 1.7 | 40 | 100 | 25 | 13 | 4 |
| Example 3 | dense | 1.7 | 30 | 100 | 23 | 5.9 | 12 |
| Comparative | dense | 1.7 | 150 | 30 | 25 | 18 | 4 |
| Example 1 | | | | | | | |

The results in Tables 1 and 2 show that the fuel cell separators obtained in each of the examples according to the invention had, in both the porous and dense areas therein, smaller variations in thickness than the separators obtained in the comparative example. Moreover, because the porous areas had a high porosity, the degree of impregnation by the binder was also high, indicating excellent binder impregnation. Other properties, including the gas permeability, flexural strength and flexural modulus, were at acceptable levels for practical purposes.

As described above, in the method of fabricating fuel cell separators according to the invention, a porous molding material is charged into a mold, the porous material is compression molded to create a porous molded body, and predetermined regions of the porous molded body are impregnated with a binder to form dense areas. This process can be used for the low-cost, high-volume production of fuel cell separators having a dense structure, which separators, even when bearing a complex channel geometry, can readily be imparted with a uniform density and uniform pores and moreover exhibit a high planar and dimensional precision.

Japanese Patent Application No. 2002-234737 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A method of manufacturing fuel cell separators, comprising the steps of:
(a) charging a porous molding material into a compression mold,
(b) compression molding the porous material at a pressure of 0.98 to 19.6 MPa to create a porous molded body, and
(c) impregnating predetermined regions of the porous molded body with a binder to form dense areas.

2. The method of claim 1, wherein the pressure during compression molding is 4.9 to 14.7 MPa.

3. The method of claim 1, wherein the porous molded body has a porosity of 1 to 50%.

4. The method of claim 1, wherein impregnation with the binder is carried out at a temperature of 0 to 200° C. and a pressure of −0.1 to 2.0 MPa.

5. A fuel cell separator obtained by the fuel cell manufacturing method of claim 1.
